(19) United States
(12) Patent Application Publication
(10) Pub. No.: US 2009/0182887 A1
(43) Pub. Date: Jul. 16, 2009

(54) Data transmission and writing method using multicast data flows

(75) Inventors: Yue Zhang, Tianjin (CN); Tom Chen, Taipei (TW); Win-Harn Liu, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 12/007,842

(22) Filed: Jan. 16, 2008

(51) Int. Cl. G06F 15/16

(52) U.S. Cl. 709/231

(57) ABSTRACT

A data transmission and writing method using multicast data flows is used for performing data transmission and writing operation of a mirror file on one or more client computers simultaneously by multicast data flows sent from various servers, in a network system architecture having a plurality of client computers and servers. Firstly, the client computer sends a request information to each server in the network by using a broadcast protocol, then the client computer is added into a plurality of multicast data flows sent by a plurality of corresponding servers according to response of each server. The data of different designated parts of the mirror file required to be downloaded is received, and the received data is finally written into a disk of the client computer. This method effectively improves data transmission amount through multicast technique of network and by fully utilizing hardware performance of the client computers.

### BACKGROUND OF THE INVENTION

1. Field of Invention

The present invention relates to a data transmission and writing method using multicast data flows. More particularly, the present invention relates to a method capable of performing data transmission and writing operation of a mirror file on one or more client computers simultaneously by using a plurality of multicast data flows sent from a plurality of servers, in a network system architecture having a plurality of client computers and a plurality of servers.

2. Related Art

Currently, in enterprise environments, mapping management of computers is one of the important components in an enterprise computer management scheme, and is a basic of the computer management. In a conventional system and data copying method, firstly a standard sample system is made into a mirror file, then the mirror file is downloaded by a client to a local machine if necessary, and the data is then extracted to be restored on a local disk, so as to finish the process of copying the system and the data.

In factory environments of producing notebook computers, the method of separately downloading and restoring the mirror file for each computer has a quite low efficiency, and usually a multicast network protocol is adopted to install operating system and software for a great number of machines. Generally, the data of one mirror file is only transmitted in one multicast data flow, but when the data receiving capability of the client computer is much higher than the data transmission capability of the multicast data flow sent by the server, remaining hardware performance advantages of the client computer may be wasted.

Therefore, in the field, it is urgent to provide a data transmission and writing method capable of fully using the hardware performance of the client computer to effectively improve the data transmission amount.

### SUMMARY OF THE INVENTION

In order to solve problems and defects in the conventional art, the present invention is directed to a data transmission and writing method using multicast data flows capable of transmitting and writing the data of different parts in one mirror file to one or more client computers simultaneously by using a plurality of multicast data flows sent from a plurality of servers, in a network system architecture having a plurality of client computers and a plurality of servers.

A data transmission and writing method using multicast data flows provided by the present invention includes:

(a) a client computer sending a request information to each server in a network using a broadcast protocol, in which the request information includes a name of a mirror file to be downloaded by the client computer;

(b) after receiving the request information from the client computer, each server feeding information of a data flow being sent on the server back to the client computer, in which each server sends out a data block sequence in a designated scope in the mirror file simultaneously with a plurality of data flows in a multicast manner;

(c) the client computer collecting feedback information of each server, and surely adding into the plurality of multicast data flows sent by a plurality of corresponding servers according to the feedback information, so as to receive data of each part of the mirror file; and

(d) the client computer receiving data of the multicast data flows from different servers and writing the data into a disk of the client computer according to the initial position of sector and the number of sector in the received data.

In addition, in the data transmission and writing method using multicast data flows of the present invention, the step (b) further includes:

extracting the name of the mirror file to be downloaded by the client computer in the request information of the client; retrieving whether the multicast data flow sending the data of the mirror file exists on each server; if the multicast data flow sending the data of the mirror file exists, feeding the information of the data flow being sent on the server back to the client computer and continuing to wait for receiving the request information from the client computer; and if the multicast data flow sending the data of the mirror file does not exist, continuing to wait for receiving the request information from the client computer.

In addition, in the data transmission and writing method using multicast data flows of the present invention, the step (c) further includes:

the client computer receiving the feedback information of each server; and establishing a receiving mechanism according to multicast flow information in the feedback information.

In addition, in the data transmission and writing method using multicast data flows of the present invention, the step (d) further includes:

waiting for the arrival of the data in each multicast data flow; determining whether the data is arrived or not, in which if the data is arrived, the received data is put into a receiving buffer region, otherwise, continue to wait for the arrival of the data in each multicast data flow; combining the received data in each multicast data flow into a compressed data block; decompressing the compressed data in the compressed data block; obtaining the initial position of sector and the number of sector in the received data according to related information in the compressed data block, thereby writing the decompressed data into a designated position in the disk of the client computer; and determining whether all the data in the multicast data flow is received or not, in which if yes, the process ends, otherwise, wait for the arrival of the data in the multicast data flow.

To sum up, in the data transmission and writing method using multicast data flows provided by the present invention, the network multicast technique is effectively used to respectively send and transmit the data of different designated parts of one mirror file simultaneously in the plurality of multicast data flows sent by the plurality of servers. By fully utilizing the hardware performance of the client computers, one or more client computers can be simultaneously added into the plurality of multicast data flows sent by the plurality of corresponding servers, so as to receive the data of various parts of the mirror file simultaneously, thereby performing the mapping management and field disposition in the computer system. Therefore, the system and data mapping copying operation is performed on one or more client computers. The present invention has the following advantages.

(1) One server can send the same data block in one mirror file to all the client computers by using the multicast technique, so as to reduce occupation of the network bandwidth during data transmission.

(2) The client computer can receive the data in the plurality of multicast data flows sent by different servers simultaneously, so as to simultaneously receive the data of various parts of the mirror file to be downloaded, thereby fully using the hardware performance of each client computer and effectively improving the data transmission amount.

(3) The data can be compressed before the data transmission, and the data can be decompressed after the client computer receives the data, so as to further reduce the occupation of the network bandwidth during data transmission.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a whole architecture of a system in which the data transmission and writing method using multicast data flows runs according to the present invention;

FIG. 2 is a system block diagram of performing the data transmission and writing operation on one of the client computers by the data transmission and writing method using multicast data flows of the present invention running in the system as shown in FIG. 1;

FIG. 3 is a flow chart of the steps of the data transmission and writing method using multicast data flows according to the present invention;

FIG. 4 is a flow chart of the fractional steps included in step 200 in the method of the present invention; and

FIG. 5 is a flow chart of the fractional steps included in steps 300 and 400 in the method of the present invention.

### DETAILED DESCRIPTION OF THE INVENTION

In the following, the detailed description of the preferred embodiment of the present invention is given with the drawings.

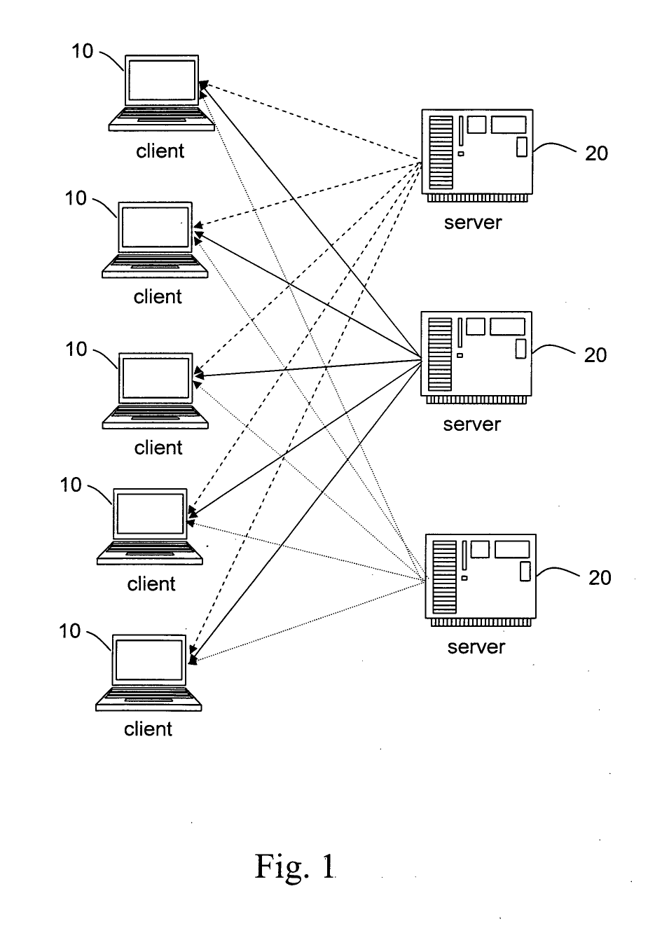

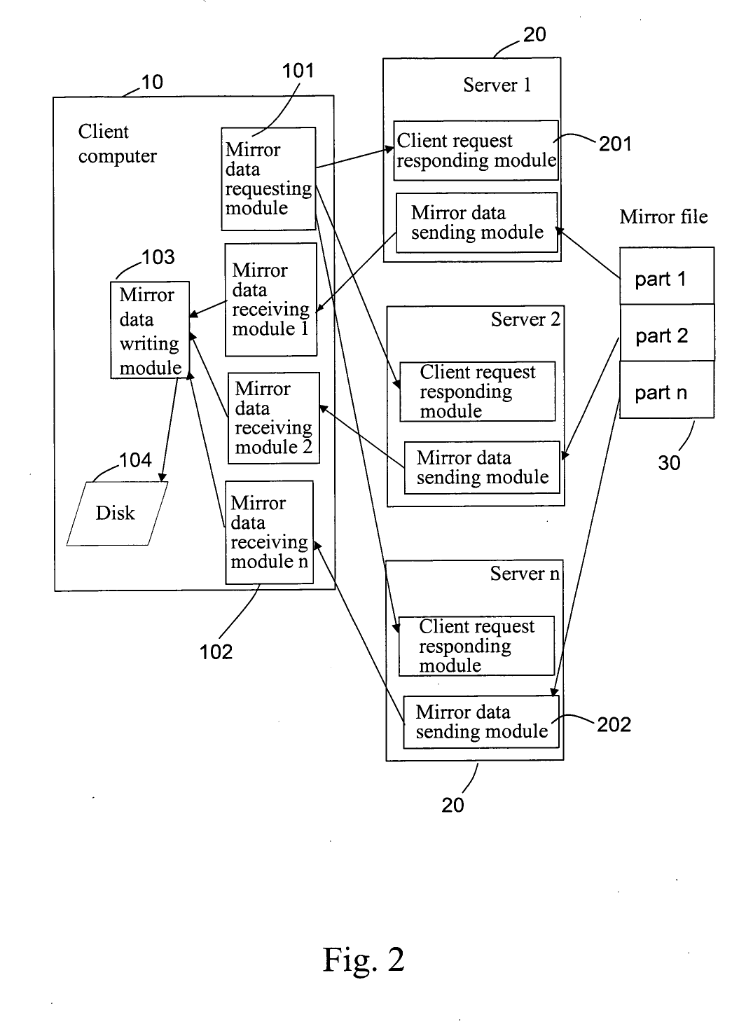

Referring to FIGS. 1 and 2, FIG. 1 is a schematic view of a whole architecture of a system in which the data transmission and writing method using multicast data flows runs according to the present invention, and FIG. 2 is a system block diagram of performing the data transmission and writing operation on one of the client computers by the data transmission and writing method using multicast data flows of the present invention running in the system as shown in FIG. 1. As shown in FIGS. 1 and 2, the system in which the data transmission and writing method using multicast data flows of the present invention runs includes:

a plurality of client computers 10, in which each client computer 10 further includes a mirror data requesting module 101, a plurality of mirror data receiving modules 102, a mirror data writing module 103, and a disk 104; and

a plurality of servers 20, in which each server 20 further includes a client request responding module 201 and a mirror data sending module 202.

The mirror data requesting module 101 in each client computer 10 can send a request information to each server 20 in the network by using the broadcast protocol, and the request information includes a name of a mirror file 30 required to be downloaded by the client computer 10.

After the client request responding module 201 in each server 20 receives the request information from the client computer 10, the server 20 feeds the information of the data flow being sent on the server 20 back to the client computer 10, in which each server 20 circularly sends outwards a data block sequence in a designated scope in the mirror file 30, i.e., a part of the data in the mirror file 30, simultaneously with a plurality of data flows in a multicast manner by using the mirror data sending module 202, as shown in the drawing, each part of the data in the mirror file 30 can be represented by part 1, part 2 . . . part n.

After the client computer 10 collects the feedback information of each server 20 through the mirror data requesting module 101, the client computer 10 is surely added into a plurality of multicast data flows sent by the plurality of corresponding servers 20 according to the feedback information, so as to receive the data of each part of the mirror file 30.

Each mirror data receiving module 102 in each client computer 10 is used to receive the data in one multicast data flow, so as to combine the received data in each multicast data flow to a compressed data block, and then to respectively send the compressed data blocks to the mirror data writing module 103.

After receiving the compressed data blocks sent from the data receiving modules 102, the mirror data writing module 103 firstly decompresses the compressed data in the compressed data blocks, obtains the initial position of sector and the number of sector in the received data according to the related information included in the compressed data blocks, and writes the decompressed data into a designated position in the disk 104 of the client computer 10 according to the initial position of sector and the number of sector in the received data, so as to finish the data transmission and writing operation of the mirror file 30.

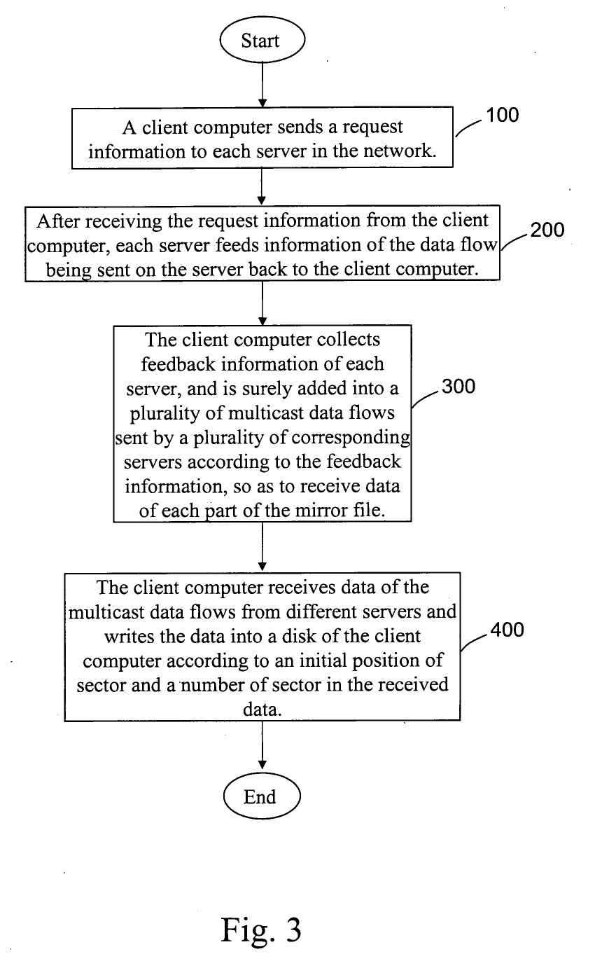

Referring to FIG. 3, a flow chart of the whole step of the data transmission and writing method using multicast data flows of the present invention is shown. As shown in the drawing, the data transmission and writing method using multicast data flows of the present invention includes the following steps.

A client computer sends a request information to each server in the network by using a broadcast protocol, in which the request information includes a name of the mirror file to be downloaded by the client computer (step 100).

After receiving the request information from the client computer, each server feeds information of the data flow being sent on the server back to the client computer, in which each server circularly sends outwards a data block sequence in a designated scope in the mirror file simultaneously with a plurality of data flows in a multicast manner (step 200).

The client computer collects feedback information of each server, and is surely added into the plurality of multicast data flows sent by the corresponding servers according to the feedback information, so as to receive data of each part of the mirror file (step 300), in which the feedback information of each server includes an IP address and a port number of the multicast data flow of each server; if the client computer does not receive the feedback information of the server, the client computer sends an error information (not shown).

The client computer receives data of the multicast data flows from different servers and writes the data into the disk of the client computer according to the initial position of sector and the number of sector in the received data (step 400).

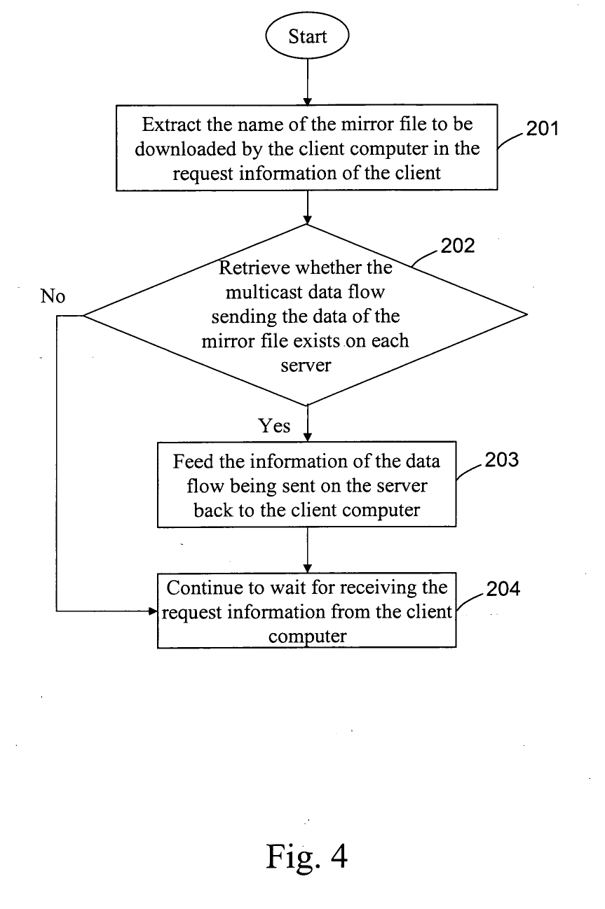

As shown in FIG. 4, step 200 can further includes:

extracting the name of the mirror file to be downloaded by the client computer in the request information of the client (step 201);

retrieving whether the multicast data flow sending the data of the mirror file exists on each server (step 202);

if the multicast data flow sending the data of the mirror file exists, feeding the information of the data flow being sent on the server back to the client computer (step 203), and continuing to wait for receiving the request information from the client computer (step 204);

if the multicast data flow sending the data of the mirror file does not exist, performing step 204 to continue to wait for receiving the request information from the client computer.

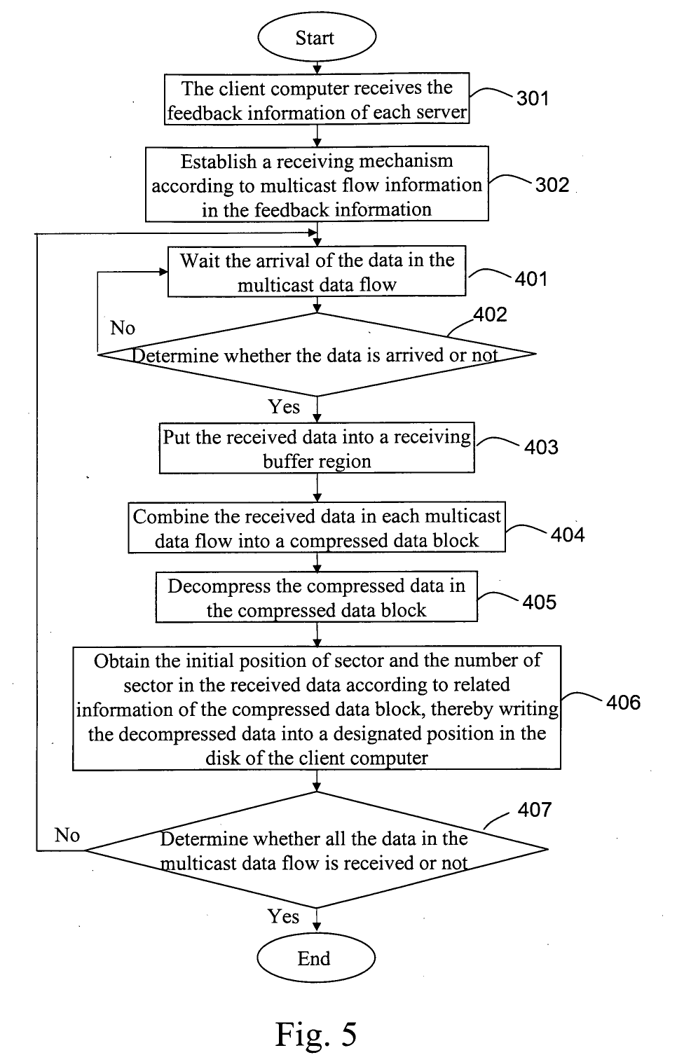

As shown in FIG. 5, in the data transmission and writing method using multicast data flows of the present invention, steps 300 and 400 can further include:

the client computer receiving the feedback information of each server (step 301), in which the feedback information includes the IP address and the port number of the multicast data flow of each server;

establishing a receiving mechanism according to multicast flow information in the feedback information (step 302), that is, each client computer is added into the corresponding multicast data flow sent by each server to receive the data of each part of the mirror file;

waiting for the arrival of the data in the multicast data flow (step 401);

determining whether the data is arrived or not (step 402), in which if yes, the received data is put into a receiving buffer region (step 403), otherwise, the process returns to perform the step 401;

combining the received data in each multicast data flow into a compressed data block (step 404);

decompressing the compressed data in the compressed data block (step 405);

obtaining the initial position of sector and the number of sector in the received data according to related information of the compressed data block, thereby writing the decompressed data into a designated position in the disk of the client computer (step 406); and

determining whether all the data in the multicast data flow is received or not (step 407), in which if yes, the process ends, otherwise, the process returns to perform the step 401.

The compressed data block in the step includes a data region containing compressed sector data, and the compressed data block includes:

a data block number, being an integer, for representing a position of the compressed data block in the data block sequence of the mirror file;

a data block size, being an integer, for representing a data amount in the compressed data block;

an initial sector number of disk, being an integer, for representing an initial position of a physical disk in which the data in the compressed data block is located; and

a number of sector, being an integer, for representing the number of sectors occupied by the data in the compressed data block.

What is claimed is:

1. A data transmission and writing method using multicast data flows, for performing data transmission and writing operation of a mirror file simultaneously on one or more client computers by using a plurality of multicast data flows sent from a plurality of servers, in a network system architecture having a plurality of client computers and a plurality of servers, comprising:
(a) a client computer sending a request information to each server in a network by using a broadcast protocol, wherein the request information comprises a name of the mirror file to be downloaded by the client computer;
(b) after receiving the request information from the client computer, each server feeding information of the data flow being sent on the server back to the client computer, wherein each server sends out a data block sequence in a designated scope in the mirror file simultaneously with the plurality of data flows in a multicast manner;
(c) the client computer collecting feedback information of each server, and surely adding into the multicast data flows sent by the corresponding servers according to the feedback information, so as to receive data of each part of the mirror file; and
(d) the client computer receiving the data of the multicast data flows from different servers and writing the data into a disk of the client computer according to the initial position of sector and the number of sector in the received data.

2. The data transmission and writing method using multicast data flows as claimed in claim 1, wherein the feedback information of each server comprises Internet protocol (IP) address and port number of the multicast data flow of each server.

3. The data transmission and writing method using multicast data flows as claimed in claim 1, wherein the step (b) further comprises:
extracting the name of the mirror file to be downloaded by the client computer in the request information of the client;
retrieving whether the multicast data flow sending the data of the mirror file exists on each server;
if the multicast data flow sending the data of the mirror file exists, feeding the information of the data flow being sent on the server back to the client computer and continuing to wait for receiving the request information from the client computer; and
if the multicast data flow sending the data of the mirror file does not exist, continuing wait for receiving the request information from the client computer.

4. The data transmission and writing method using multicast data flows as claimed in claim 1, wherein the step (c) further comprises:
the client computer receiving the feedback information of each server; and
establishing a receiving mechanism according to multicast flow information in the feedback information.

5. The data transmission and writing method using multicast data flows as claimed in claim 1, wherein the step (d) further comprises:
waiting for the arrival of the data in each multicast data flow;
determining whether the data is arrived or not, wherein if the data is arrived, the received data is put into a receiving buffer region, otherwise, continue to wait for the arrival of the data in each multicast data flow;
combining the received data in each multicast data flow into a compressed data block;
decompressing the compressed data in the compressed data block;
obtaining the initial position of sector and the number of sector in the received data according to related information of the compressed data block, thereby writing the decompressed data into a designated position in the disk of the client computer; and
determining whether all the data in the multicast data flow is received or not, wherein if yes, the process ends, otherwise, wait for the arrival of the data in the multicast data flow.

6. The data transmission and writing method using multicast data flows as claimed in claim 5, wherein the compressed data block comprises a data region, the data region comprises the compressed sector data, and the compressed data block comprises:
a data block number, being an integer, for representing a position of the compressed data block in the data block sequence of the mirror file;
a data block size, being an integer, for representing a data amount in the compressed data block;
an initial sector number of disk, being an integer, for representing an initial position of a physical disk in which the data in the compressed data block is located; and
a number of sector, being an integer, for representing the number of sectors occupied by the data in the compressed data block.
